(19) United States
(12) Patent Application Publication
(10) Pub. No.: US 2017/0006841 A1
(43) Pub. Date: Jan. 12, 2017

(54) ANIMAL/PLANT ENVIRONMENT CONTAINER

(71) Applicant: HONEST STAR ENTERPRISES LIMITED, Kwai Chung (HK)

(72) Inventors: Tatsuya HATTORI, Osaka (JP); Kazutoshi TOMINAGA, Osaka (JP); Kazuhiko ISHII, Osaka (JP)

(73) Assignee: HONEST STAR ENTERPRISES LIMITED, KWAI CHUNG (HK)

(21) Appl. No.: 15/205,821

(22) Filed: Jul. 8, 2016

(30) Foreign Application Priority Data
Jul. 9, 2015 (JP) 2015-137420

(51) Int. Cl. A01K 63/00; A01G 9/02

(52) U.S. Cl. CPC A01K 63/003; A01G 9/02

(57) ABSTRACT

An animal/plant environment container includes a container body having a floor, a peripheral wall, and a ceiling wall, and a water-storable watertight section provided at a lower portion of the container body. A floor surface of the floor includes an inclined surface inclined downward toward a front side. A drain hole for discharging water in the watertight tank section to an outside of the container body is formed at a lower end section of a front wall of the peripheral wall.

### CROSS-REFERENCE TO THE RELATED APPLICATIONS

The present application claims priority to Japanese Patent Application No. 2015-137420 filed on Jul. 9, 2015, the entire disclosure of which is incorporated herein by reference in its entirety.

### BACKGROUND OF THE INVENTION

Field of the Invention

The present disclosure relates to an animal and/or plant (in this disclosure, “animal and/or plant” will be referred to as “animal/plant”) environment container for keeping small animals, such as, e.g., amphibians, reptiles, insects, and small aquatic animals, and/or ornamental plants for, e.g., observation or ornamental purposes while raising/cultivating such animals/plants.

Description of the Related Art

The following description of related art sets forth the inventors' knowledge of related art and certain problems therein and should not be construed as an admission of knowledge in the prior art.

Conventionally, a terrarium and an aqua terrarium are well-known, in which small animals, such as, e.g., frogs, turtles, snakes, crocodiles, lizards, scorpions, spiders, snails, dragonflies, and small fish, and/or ornamental plants, such as, e.g., fern, are kept while raising/cultivating them.

For example, Japanese Utility Model registration No. 3110647 (Hereinafter, Patent document 1) and Japanese Unexamined Laid-open Patent Application Publication No. H10-117625 (Hereinafter, Patent Document 2) each discloses an animal/plant environment container preferably used as, e.g., a terrarium.

When keeping animals and/or plants in an animal/plant environment container as shown in the aforementioned Patent Documents 1 and 2, it is normal to arrange laying materials, such as, e.g., stones, gravels, sands, soils, mosses, fallen leaves, and fallen branches, on a floor surface in the container and also arrange layout components, such as, e.g., artificial plants, artificial rocks, and bowls for puddle formation, if necessary. Further, water is sprayed into such an animal/plant environment container to moisten the laying materials, etc., or water is introduced so as to be accumulated in the animal/plant environment container to such an extent that at least a part of the laying materials is immersed. In this manner, the humidity, etc., in the container is controlled so that the raising/cultivating environment comfortable for animals and/or plants can be obtained.

In such a conventional animal/plant environment container, however, there is a problem that cleaning of the inside of the container is troublesome due to the poor drainage. That is, in the case of cleaning a conventional animal/plant environment container with water, a large amount of water used for the cleaning will be accumulated in the container. In this case, it is difficult to maintain the container in a comfortable raising/cultivation environment with the water accumulated in the container. For this reason, it is required to drain the excess water from the container. However, the excess water cannot be easily drained in a state in which laying materials, such as, e.g., stones, gravels, sands, soils, fallen leaves, and fallen branches, remain in the container. Therefore, it is required to take out laying materials and/or layout parts from the container and then drain the excess water at the time of cleaning. Further, after draining the excess water, it is required to re-arrange the laying materials and/or the layout parts with care. As will be apparent from the above, in a conventional animal/plant environment container, it was required to perform troublesome operations, such as, e.g., taking in/out laying materials and/or layout parts at the time of cleaning, which was troublesome to perform cleaning of the container.

The description herein of advantages and disadvantages of various features, embodiments, methods, and apparatus disclosed in other publications is in no way intended to limit the present invention. For example, certain features of the preferred described embodiments of the invention may be capable of overcoming certain disadvantages and/or providing certain advantages, such as, e.g., disadvantages and/or advantages discussed herein, while retaining some or all of the features, embodiments, methods, and apparatus disclosed therein.

### SUMMARY OF THE INVENTION

The disclosed embodiments of this disclosure have been developed in view of the above-mentioned and/or other problems in the related art. The disclosed embodiments of this disclosure can significantly improve upon existing methods and/or apparatuses.

Some embodiments of the present invention were made in view of the aforementioned problems, and aim to provide, for example, an animal/plant environment container excellent in water drainage and capable of easily cleaning an inside of the container.

The other purposes and advantages of some embodiments of the present invention will be made apparent from the following preferred embodiments.

In order to attain the aforementioned objects, some embodiments of the present invention have the following structure.

[1] An animal/plant environment container, includes a container body including a floor, a peripheral wall, and a ceiling wall, and a water-storable watertight tank section provided at a lower portion of the container body. A floor surface of the floor includes an inclined surface inclined downward toward a front side, and a drain hole configured to discharge water in the watertight tank section to an outside of the container body is formed at a lower end section of a front wall of the peripheral wall.

[2] In the animal/plant environment container as recited in the aforementioned Item [1], it can be configured such that an approximately entire area of the floor surface is formed into an inclined surface, and an inclination angle of the inclined surface is set to 2° to 8°.

[3] In the animal/plant environment container as recited in the aforementioned Item [1] or [2], it can be configured to further include an opening/closing member configured to open and close the drain hole.

[4] In the animal/plant environment container as recited in any one of the aforementioned Items [1] to [3], it can be configured such that a drain pipe/tube is attached to a lower end section of the front wall in a manner as to penetrate the front wall, and the drain hole is formed by a pipe hole of the drain pipe.

[5] In the animal/plant environment container as recited in the aforementioned Item [4], it can be configured such that a recessed part recessed backward and opened forward is formed in a lower end section of the front wall, and the drain pipe is arranged in the recessed part and a front end of the drain pipe is positioned rearward of a front end opening face of the recessed part.

[6] In the animal/plant environment container as recited in any one of the aforementioned Items [1] to [5], it can be configured such that the container body has a rectangular shape in vertical cross-sectional view, an upper ventilation opening is provided at an upper end section of the container body, a lower ventilation opening is provided at a lower end section of the peripheral wall, and the upper ventilation opening and the lower ventilation opening are arranged at diagonal positions of the container body in vertical cross-section.

[7] In the animal/plant environment container as recited in the aforementioned Item [5], it can be configured such that an upper ventilation opening is provided at at least one of a rear wall upper end section of the peripheral wall and a rear end section of the ceiling wall, and a lower ventilation opening is provided at an upper wall section among wall sections constituting the recessed part.

[8] In the animal/plant environment container as recited in any one of the aforementioned Items [1] to [7], it can be configured such that principal parts of the floor, the peripheral wall and the ceiling wall of the container body are constituted by transparent glass plates.

According to the animal/plant environment container as recited in the aforementioned Item [1], water drainage is excellent and cleaning of the container can be easily performed by simply spraying water. That is, excess water stagnated in the watertight tank section caused by spraying water naturally flows down toward a front side along the inclined surface of the floor surface, and automatically drained through the drain hole of the front wall. For this reason, at the time of draining the excess water stagnated due to cleaning, it becomes possible to eliminate troublesome works, such as, e.g., works for taking in and out layout components, such as, e.g., a laying material in the container, which enables simple and easy cleaning.

According to the animal/plant environment container as recited in the aforementioned Item [2], water stagnated in the watertight tank section can be efficiently discharged more smoothly.

According to the animal/plant environment container as recited in the aforementioned Item [3], by closing the drain hole with an opening/closing member, a predetermined amount of water can be stored in the watertight tank section, which enables raising/cultivating of animals/plants under a water stagnated circumstance. If necessary, by opening the drain hole by detaching or operating the opening/closing member, it becomes possible to easily discharge the water in the watertight tank section.

According to the animal/plant environment container as recited in the aforementioned Item [4], since the drain pipe is attached to the front wall in a penetrated manner, by, for example, connecting an external drain tube to the drain pipe, it becomes possible to easily discharge the water stagnated in the watertight tank section to a desired portion via the external drain tube. This enhances the convenience.

According to the animal/plant environment container as recited in the aforementioned Item [5], the drain pipe is arranged at the recessed part formed at the front wall so that the drain pipe is not protruded from the front opening of the recessed part. For this reason, the drain pipe is not protruded from the front face of the animal/plant environment container, which enables arrangement of a plurality of animal/plant environment containers in a contact manner or in a closely arranged manner in the front and rear direction, for example, at a store or an exhibition site. Further, since the drain pipe is not protruded, the animal/plant environment container can be packaged easily and compactly. Further, it becomes possible to prevent the drain pipe from being inadvertently interfered with, e.g., operator's clothes or peripheral devices at the time of, e.g., carrying the container, which in turn can prevent a trouble such as a damage of the drain pipe.

According to the animal/plant environment container as recited in the aforementioned Item [6], since the lower ventilation opening and the upper ventilation opening are arranged at diagonal positions of the container body as seen in a vertical cross-section, the air introduced in the container from one of the ventilation openings prevails around the entire region in the container and is discharged from the other ventilation opening. Therefore, the entire region in the container can be ventilated evenly, which results in a comfortable raising/cultivating environment in the entire region of the container.

According to the animal/plant environment container as recited in the aforementioned Item [7], since the lower ventilation opening is formed in the recessed part retracted rearward, the lower ventilation opening is less likely recognized by an observer, which results in an improved appearance.

According to the animal/plant environment container as recited in the aforementioned Item [8], since the principal portion of the container body is formed by glass plates, dirt, etc., becomes less likely adhere to the container body, which enables easy maintenance and inspection.

### BRIEF DESCRIPTION OF THE DRAWINGS

Embodiments of the present invention are shown by way of example, and not limitation, in the accompanying figures.

FIG. 1 is a perspective view of an animal/plant environment container according to an embodiment of the present invention.

FIG. 2 is a front view of the animal/plant environment container of the embodiment.

FIG. 3 is a side cross-sectional view of the animal/plant environment container of the embodiment.

FIG. 4 is a top view of the animal/plant environment container of the embodiment.

FIG. 5 is an enlarged side cross-sectional view of a drain pipe and periphery thereof according to the animal/plant environment container of the embodiment.

FIG. 6 is a partially exploded enlarged side cross-sectional view of the drain pipe and periphery thereof according to the animal/plant environment container of the embodiment.

FIG. 7 is an exploded perspective view of the drain pipe and periphery thereof according to the animal/plant environment container of the embodiment.

### EMBODIMENT FOR CARRYING OUT THE INVENTION

In the following paragraphs, some embodiments of the present invention will be described by way of example and not limitation. It should be understood based on this disclosure that various other modifications can be made by those in the art based on these illustrated embodiments.

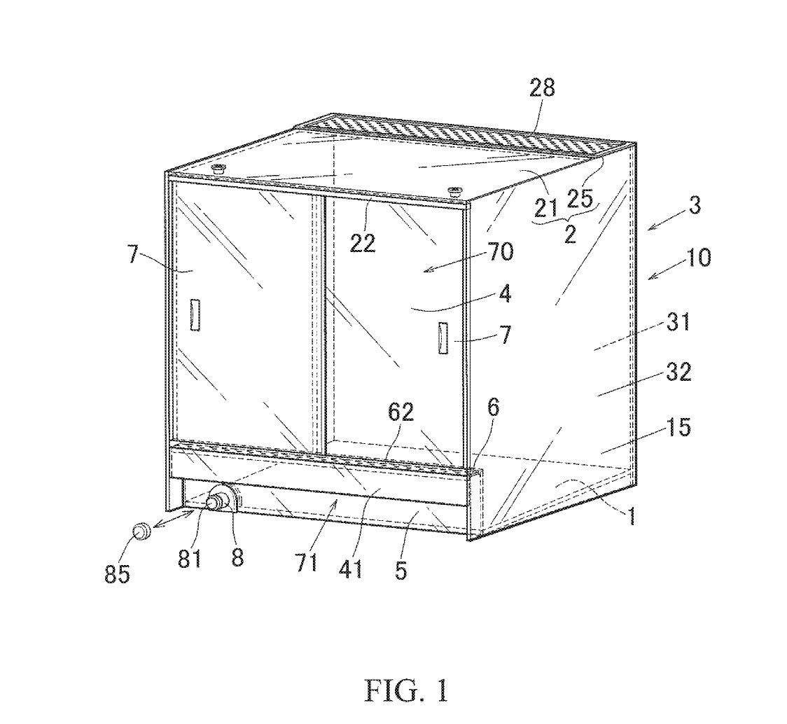

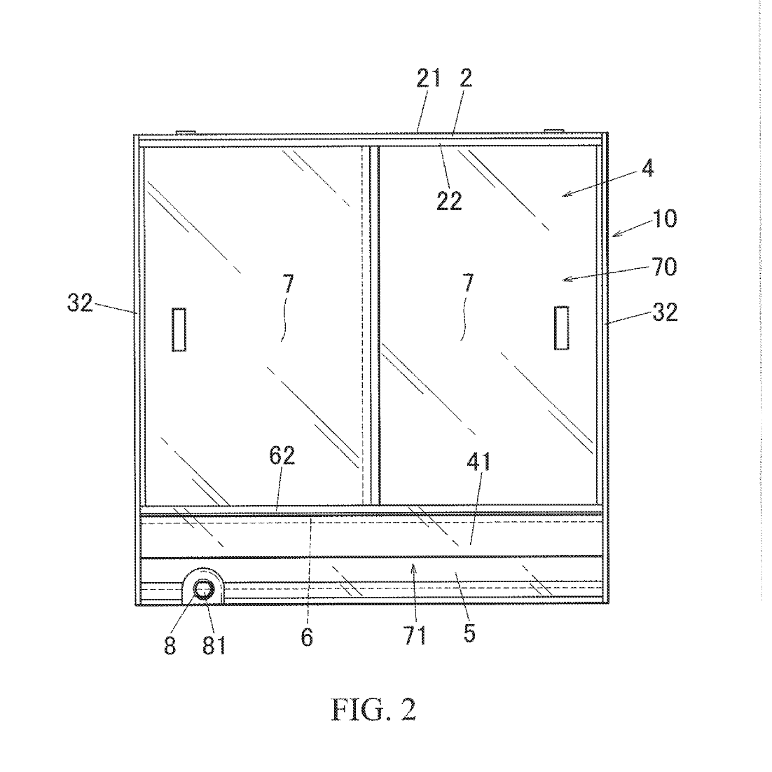

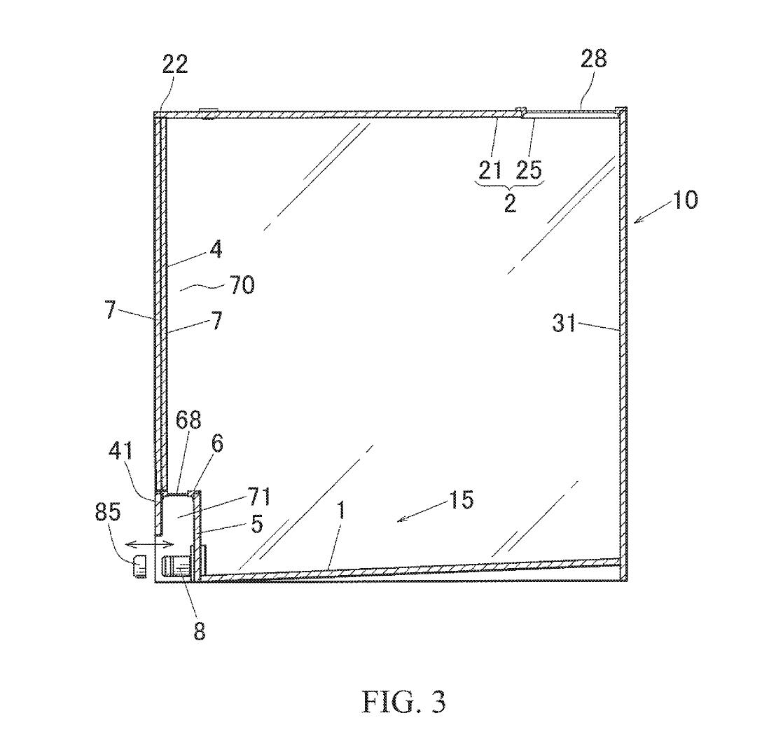

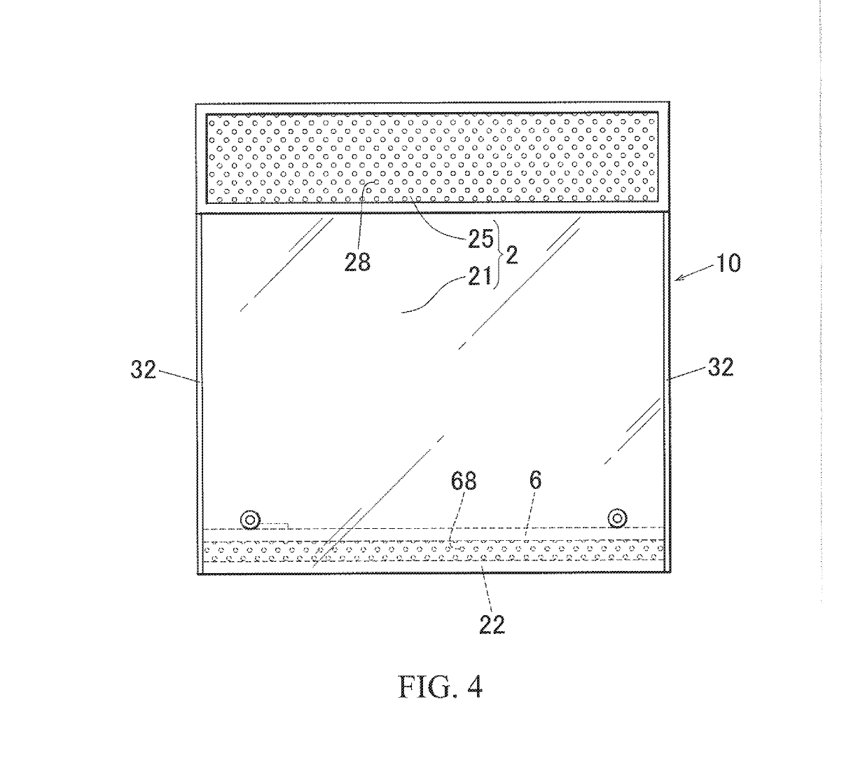

FIGS. 1 to 4 show an animal/plant environment container according to an embodiment of the present invention. As shown in these figures, this animal/plant environment container is preferably used, but not limited, as a terrarium or an aqua terrarium for keeping small animals, such as, e.g., amphibians, reptiles, insects, and small aquatic animals, and/or ornamental plants, such as, e.g., fern, for the observation/ornamental purposes while raising/cultivating them. In this disclosure, a direction from one end of an inclined floor surface which is higher in height to the other end thereof which is lower in height will be referred to as a “forward” direction. Concretely, in this embodiment, the left side in FIG. 3 is referred to as “front side”, and the right side is referred to as “rear side”.

The animal/plant environment container of this embodiment is equipped with a container body 10 having an approximately rectangular parallelepiped shape. The container body 10 is equipped with a floor 1 having a rectangular shape as viewed from the above, a peripheral wall 3 formed along the outer peripheral edge of the floor 1 so as to extend vertically upward, and a ceiling wall 2 provided at the upper opening of the peripheral wall 3. The peripheral wall 3 includes a front wall 4 arranged at a front side of the container body 10, a rear wall 31 arranged at the rear side of the container body 10, and side walls 32 and 32 arranged at the right and left sides of the container body 10.

The rear wall 31 and both the side walls 32 and 32 are each formed by a colorless transparent plate-shaped glass plate, and rear end edges of both the side walls 32 are fixed to both side edges of the rear wall 31.

The floor 1 is formed by a colorless transparent plate-shaped glass plate. A rear end edge of the floor 1 is fixed to a lower edge section of the inner side surface of the rear wall 31, and both side edges of the floor 1 are fixed to lower edge sections of inner surfaces of both the side walls 32 and 32. Further, the floor 1 has a front edge positioned rearward of the front edges of both the side walls 32 and 32, so that no floor 1 exists at the front end side of the bottom portion of the container body 10.

The floor 1 is arranged in an inclined posture in a manner as to incline downward toward the front side of the container body 10. In this embodiment, the inclination angle (i.e., angle of gradient) of the floor 1 with respect to a horizontal plane is set to be constant approximately in the entire region of the floor 1 from the rear edge thereof to the front edge thereof.

In this embodiment, the inclination angle of the floor 1 with respect to a horizontal plane is preferably set to 2° to 8° (2 degrees or larger and 8 degrees or less), more preferably 5° (5 degrees) or less. In detail, in cases where the inclination angle is excessively small, the excess water in the container cannot be smoothly drained at the time of cleaning, etc., of the tank as will be described later, which may cause deterioration of water drainage. On the other hand, in cases where the inclination angle is excessively large, it becomes difficult to stably arrange laying materials to be arranged on the floor surface and/or layout parts to be arranged in the container.

In this embodiment, the floor surface is formed by the upper surface of the floor 1, and therefore the inclination angle of the floor surface and the inclination angle of the floor 1 coincide each other.

The ceiling wall 2 includes a closing plate 21 arranged at the front side of the upper end face of the animal/plant environment container so as to extend from the front end to the intermediate section of the upper end face, and an upper ventilation plate 25 arranged at the rear end side of the upper end face of the animal/plant environment container. The upper ventilation plate 25 is made by a colorless transparent glass plate.

The upper ventilation plate 25 includes a rectangular outer frame and a punched metal or a perforated metal (hereinafter collectively referred to as “punched metal”) fixed to the outer frame. The punched metal is constituted by a metal plate or a metal sheet in which a number of small apertures are formed. In this embodiment, the punched metal forms a ventilation member and each small hole (aperture or opening) of the punched metal forms an upper ventilation opening 28.

Further, at the front edge of the lower surface of the closing plate 21, an upper rail member 22 is attached in a manner as to continuously extend in the right and left direction of the container (in the width direction of the container). This upper rail member 22 is equipped with two rail grooves arranged at the front and rear sides, so that each groove slidably supports the upper edge end of the sliding door plate 7 constituting the front wall 4.

The front wall 4 includes a front wall lower end plate 5, a horizontal lower ventilation plate 6, and a pair of sliding door plates 7 and 7.

The front wall lower end plate 5 is formed by a colorless transparent glass plate. Both side edges of the front wall lower end plate 5 are fixed to inner surfaces of both the side walls 32 and 32. This front wall lower end plate 5 is arranged vertically in such a manner that the lower end position of the front wall lower endplate 5 is arranged at a position corresponding to the front edge position of the floor 1. In other words, the front wall lower end plate 5 is arranged vertically at a position retracted from the front end position of the container body 10.

The lower ventilation plate 6 is arranged horizontally in a manner as to extend from the upper end of the front wall lower end plate 5 to the front end face of the container body 10. The rear edge of the lower ventilation plate 6 is fixed to the upper end edge of the front wall lower end plate 5, and both side edges of the lower ventilation plate 6 are fixed to inner surfaces of both side walls 32 and 32.

Further, the lower ventilation plate 6 includes front and rear frames 66 and 66 and a punched metal fitted to the front and rear frames 66 and 66. In this embodiment, the punched metal forms a ventilation member, and each small hole (aperture or opening) of the punched metal forms a lower ventilation opening 68.

On the front edge section of the upper surface of the lower ventilation plate 6, a lower rail member 62 is fixedly arranged so as to continuously extend along the right and left direction (in the width direction). This lower rail member 62 is provided with two rail grooves arranged one behind the other. These two rail grooves are arranged corresponding to two rail grooves of the upper rail member 22.

In this embodiment, a front opening 70 is formed at the front face of the container body 10 between the ceiling wall 2 and the lower ventilation plate 6. The pair of sliding door plates 7 and 7 for opening and closing the front opening 70 are each formed by a colorless transparent glass plate.

The upper edge and the lower edge of one of the pair of sliding door plates 7 and 7 are slidably fitted in the rear rail groove of the upper rail member 22 and the rear rail groove of the lower rail member 62, respectively. Further, the upper edge and the lower edge of the other of the pair of sliding door plates 7 and 7 are also slidably fitted in the front rail groove of the upper rail member 22 and the front rail groove of the lower rail member 62, respectively. With this, each sliding door plate 7 is slidably supported by the rail members 22 and 62 along the rail longitudinal direction (in the right and left direction). Accordingly, by sliding the sliding door plate 7, the front opening 70 of the container body 10 can be opened and closed.

Further, in the animal/plant environment container of this embodiment, in a state in which the front opening 70 is closed by the sliding door plates 7 and 7, a locking means (not illustrated) for limiting the sliding operations of the sliding door plates 7 and 7 is provided.

In this embodiment, the section of the front wall 4 where the front wall lower end plate 5 is arranged is retreated rearward from the front end face of the container body 10 to form a recessed part 71.

Here, in this embodiment, the front wall lower end plate 5 and the lower ventilation plate 6 form a wall portion constituting the recessed part 71. Further, the lower ventilation plate 6 constitutes an upper wall portion of the wall portion forming the recessed part 71.

Further, at the front end of the lower ventilation plate 6, an upper edge of a modesty panel 41 is fixed in a downwardly extended manner. By this modesty panel 41, the upper section of the front opening of the recessed part 71 is covered.

In the animal/plant environment container of this embodiment, a lower section of an inner space of the container body 10 defined by and between the floor surface of the floor 1 and a horizontal plane corresponding to the upper edge of the front wall lower end plate 5 forms a watertight tank section 15. More specifically, the floor 1, the front wall lower end plate 5, a lower end section of the rear wall 31, and lower end sections of both side walls 32 form the watertight tank section 15 which is capable of accumulating water.

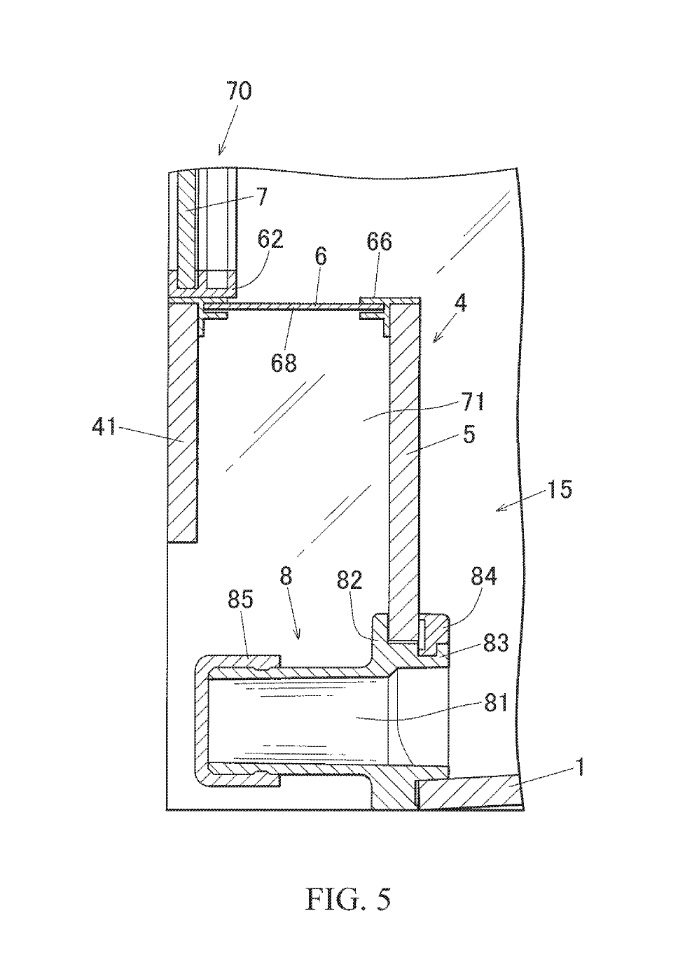

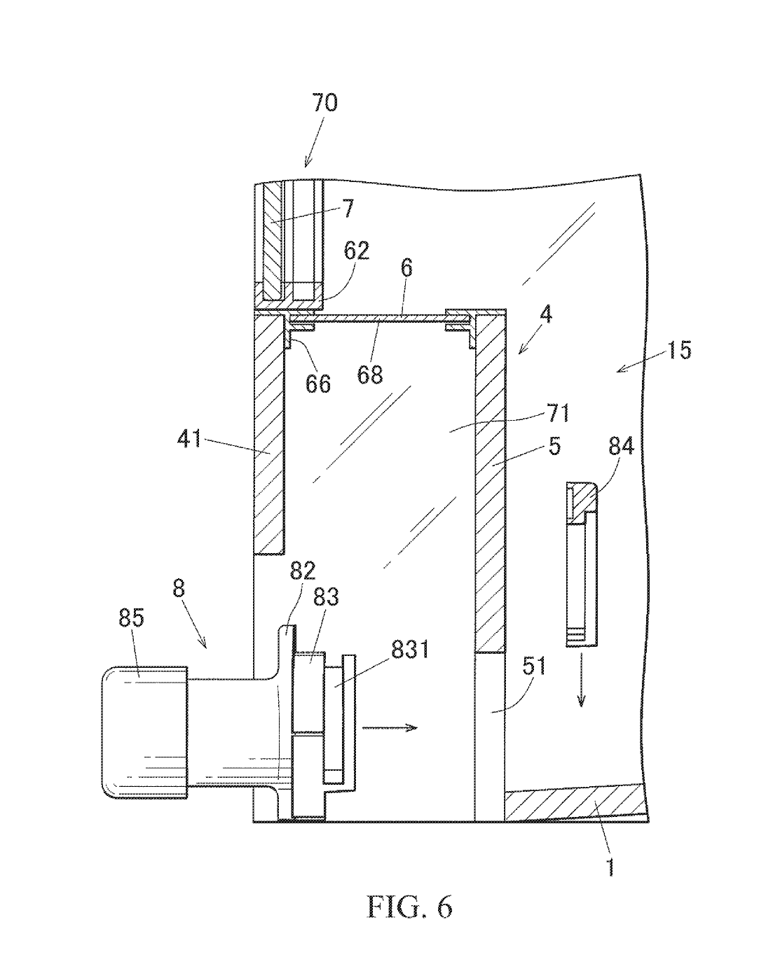

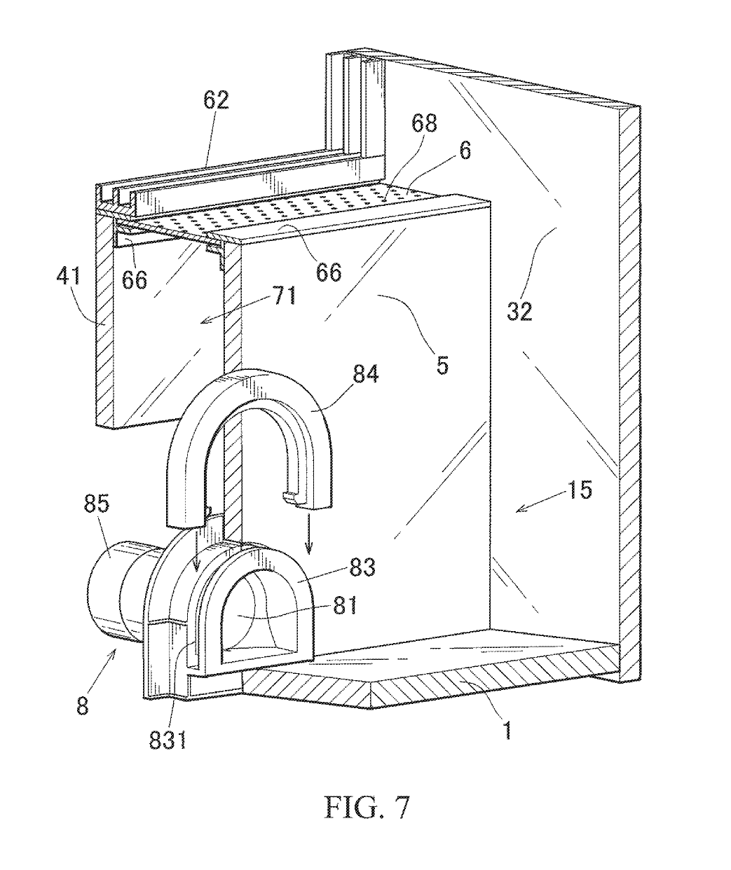

As shown in FIGS. 5 to 7, at one side end of the lower end section of the front wall lower end plate 5, a drain pipe 8 is mounted in a manner as to penetrate the front wall lower end plate 5.

In detail, at the mounting position of the front wall lower end plate 5 for mounting the drain pipe 8, an inverted U-shaped notched recess 51 which opens downward is formed.

On the other hand, the drain pipe 8 is provided with a drain hole 81 extending in an axial direction of the pipe. Further, the drainpipe 8 is provided with a flange 82 on the outer periphery of the intermediate section of the drain pipe 8, and also is provided with an insertion section 83 at the basal end side (rear end side) of the drain pipe 8. The insertion section 83 is formed into an inverted U-shape in outer cross-section corresponding to the notched recess 51 of the front wall lower endplate 5. The insertion section 83 is inserted into the notched recess 51 of the front wall lower end plate 5 from the front side in a fitted manner so that the rear end portion of the insertion section 83 is arranged rearward of the front wall lower end plate 5. Further, a fixing groove 831 is formed on the rear end portion of the insertion section 83 so as to extend from the upper portion to both side portions, and an inverted U-shaped fixing member 84 is fixedly fitted in the fixing groove 831 from above. In this state, an outer peripheral edge portion of the notched recess 51 of the front wall lower end plate 5 is held by and between the flange 82 of the drainpipe 8 and the fixing member 84. With this, the drain pipe 8 is fixed to the front wall lower end plate 5 of the front wall 4 in a penetrated manner.

The drain pipe 8 attached to the front wall lower end plate 5 is arranged in the recessed part 71. Further, in this embodiment, the entirety of the drain pipe 8 is arranged rearward of the front end opening face (front end face of the container body 10) of the recessed part 71, so that the drain pipe 8 does not protrude forward of the front end opening face of the recessed part 71.

Further, in this embodiment, the pipe hole of the drain pipe 8 constitutes the drain hole 81 communicating the inside and the outside of the container body 10.

Further, at the front end section of the drain pipe 8, a cap 85 as an opening/closing member is detachably attached. By detaching the cap 85, the drain hole 81 in the drain pipe 8 is opened, so that the water stagnated in the watertight tank section 15 in the container body 10 is discharged to the outside of the container body 10 through the drain hole 81. Further, by attaching the cap 85 to the front end section of the drain pipe 8, the drain hole 81 is closed to prevent discharging of the water in the watertight tank section 15. In this embodiment, even in the state in which the cap 85 is attached to the drain pipe 8, it is configured such that the cap 85 does not protrude forward of the front end opening face of the recessed part 71.

Further, in the container body 10, a strainer (not illustrated) is detachably attached to the rear end section of the drain pipe 8. This strainer prevents laying materials arranged in the watertight tank section 15 from being introduced into the drain hole 81 of the drain pipe 8 together with water. Therefore, the laying materials, etc., are prevented from flowing out through the drain hole 81 together with water.

The animal/plant environment container of this embodiment structured as mentioned above is in many cases used, but not limited, for a terrarium or an aqua terrarium. For example, in the watertight tank section 15 located at the lower section in the container body 10, laying materials, such as, e.g., stones, gravels, sands, soils, mosses, fallen leaves, and fallen branches, are laid on the floor 1, and layout components, such as, e.g., artificial plants, artificial rocks, and bowls for puddle formation, are arranged on the laying materials as needed. Further, water is sprayed so as to be absorbed by the laying materials, or water is supplied to the inside of the watertight tank section 15 to such a degree that at least the laying materials are partially immersed. Thus, the inside of the container is adjusted to form a raising/cultivating environment comfortable for animals/plants to be raised/cultivated. With this state, preferred animals/plants are accommodated in the container to raise/cultivate them.

As mentioned above, according to the animal/plant environment container of this embodiment, since water can be accumulated in the watertight tank section 15, aquatic small animals, such as, e.g., small fish, or amphibians, such as, e.g., frogs and newts, can be raised. Further, by arranging laying materials, land small animals including, for example, reptiles, such as, e.g., turtles, dragonflies and scorpions, can also be raised. Further, various kinds of appreciation/ornamental plants, such as, e.g., ferns, can also be cultivated. As explained above, the container of this embodiment is equipped with excellent general versatility capable of keeping various kinds of animals/plants.

Further, in the animal/plant environment container of this embodiment, the floor surface is constituted by an inclined surface inclined downward as it advances forward and the drain pipe 8 is attached to the lower end section of the front wall 4. This enables cleaning of the inside of the container body 10 by merely spraying water into the container. That is, the excess water accumulated in the watertight tank section 15 at the time of cleaning naturally flows down forward along the forwardly inclined floor surface to be automatically discharged through the drain hole 81 of the drain pipe 8. For this reason, it becomes possible to eliminate troublesome works, such as, e.g., taking out laying materials and/or layout components from the container body 10 for discharging the excess water, and re-arranging laying materials and/or layout components in the container body 10 after discharging the excess water. As will be apparent from the above, according to the animal/plant environment container of this embodiment, troublesome works, such as, e.g., taking in and out laying materials and/or layout components, can be eliminated at the time of cleaning, which enables easy cleaning.

Further, in the container of this embodiment, since the drain pipe 8 is attached to the front wall 4, the excess water in the container will be discharged forward via the drain pipe 8. This enables collection of the discharged water at the front side of the container. Thus, discharged water processing can be performed easily at the front side of the container.

Especially in this embodiment, the drain pipe 8 is attached to the front wall lower endplate 5 in a penetrated manner and the drain pipe 8 is protruded forward. Therefore, by connecting an external drain tube to the front protruded portion of the drain pipe 8, the water discharged through the drain pipe 8 can be assuredly collected to a desired discharging place via the external drain tube.

Further, in this embodiment, the cap 85 is detachably attached to the drain pipe 8. Thus, by attaching the cap 85 to the drain pipe 8, the outflow of water from the drain hole 81 can be prevented, and a predetermined amount of water can be assuredly kept in the container. For this reason, in the animal/plant environment container of this embodiment, aquatic animals, amphibians, etc., can be raised without any inconveniences. Thus, the container can be preferably used, but not limited, as an aqua terrarium. Needless to say, by detaching the cap 85 from the drain pipe 8, the water in the container can be easily discharged or drained.

Further, in this embodiment, the drain pipe 8 is arranged at the recessed part 71 of the front wall 4, and the drain pipe 8 is arranged so as not to protrude forward of the front end face of the recessed part 71. Therefore, the drain pipe 8 is not protruded from the front face of the animal/plant environment container, which enables arranging of a plurality of animal/plant environment containers in a closely-arranged manner or in a contact manner in the front and rear direction. This results in easy handling.

Further, the drain pipe 8 is not protruded from the outer surface of the animal/plant environment container. Therefore, the container can be packaged in an easy and compact manner, and it becomes possible to prevent the drain pipe 8 from being inadvertently interfered with, e.g., operator's clothes or peripheral devices at the time of, e.g., carrying the container, which in turn can assuredly prevent a trouble such as a damage of the drain pipe 8.

Further, in the animal/plant environment container of this embodiment, the upper ventilation openings 28 are formed in the upper ventilation plate 25 arranged at the rear side of the ceiling wall 2, and the lower ventilation openings 68 are formed in the horizontal lower ventilation plate 6 constituting the recessed part 71 of the front wall 4. In other words, the upper ventilation opening 28 and the lower ventilation opening 68 are formed at two diagonal positions of the container body 10 in a side cross-sectional view as shown in FIG. 3. Thus, the air introduced into the container through one of the upper ventilation opening 28 and the lower ventilation opening 68, for example, the air introduced into the container through the lower ventilation opening 68, will be discharged through the other openings 28, i.e., the upper ventilation openings 28, after prevailing the whole area in the container. This enables even ventilation of the entire inner region of the container, resulting in an improved aeration performance. With this, the distribution of the temperature and/or that of the humidity in the container becomes even. As a result, the entire region in the container can be adjusted to establish a comfortable raising/cultivating environment in the container.

In this embodiment, the upper ventilation openings 28 can be formed in at least one of the rear side of the ceiling wall 2 and the upper side of the rear wall 31. In this case, since the upper ventilation openings 28 and the lower ventilation openings 68 are arranged at diagonal positions of the container body 10 in a side cross-sectional view, an excellent aeration performance can be obtained in the same manner as mentioned above.

Further, in this embodiment, since the lower ventilation openings 68 are arranged at the recessed part 71 retreated rearward, the lower ventilation openings 68 are relatively hard to be visually recognized, ensuring an excellent appearance.

Further, in this embodiment, since the principle part of the container body 10 is structured by glass plates, contaminations, etc., hardly adhere, enabling easy maintenance and inspection.

In this embodiment, the ventilation members of the lower ventilation plate 6 and the upper ventilation plate 25 are each constituted by a punched metal having a number of small apertures or openings. However, in the present invention, the ventilation member is not limited to a punched metal, and can be constituted by any members as long as it has air permeability. For example, the ventilation member can be constituted by a mesh sheet or an expand metal.

Further, in the present invention, the shape of the small opening formed in a porous member as a ventilation member is not specifically limited, and can be of any shape, such as, e.g., a circular shape, a polygonal shape, an irregular shape, and a slit-like elongated shape.

Further, in the aforementioned embodiment, the entire region of the upper surface (floor surface) of the floor 1 is formed into an inclined surface, but not limited to it. In the present invention, it is enough that at least a part of the floor surface is formed into an inclined surface inclined downward as it advances forward.

Further, in the aforementioned embodiment, the entire region of the floor surface is set to be a constant inclination angle, but not limited to it. In the present invention, the inclination angle of the floor surface can be changed at any positions of the floor surface. For example, it can be configured such that the inclination of the floor surface gradually decreases or increases as it advances forward.

Further, in the aforementioned embodiment, the cap 85 is used as an opening/closing member of the drain pipe 8. In the present invention, however, the opening/closing member is not limited to it. In the present invention, an openable valve can be provided in the drain pipe 8 as an opening/closing member. In this case, for example, by providing a lever or a handle to the drain pipe 8, etc., to open/close the openable valve by the lever operation or the handle operation, the opening and closing operations can be performed easily.

Further, in the present invention, an opening/closing member such as the cap 85, etc., is not always required. It can be configured such that only the drain pipe 8 always in an open state can be provided. Further, the drain pipe 8 is not always required, and only a through-hole (drain hole) may be formed in the front wall 4 without providing the drain pipe 8.

Further, in the aforementioned embodiment, the upper ventilation openings 28 are formed at the rear upper side of the container body 10 and the lower ventilation openings 68 are formed at the front lower side of the container body 10, so that the upper ventilation openings 28 and the lower ventilation openings 68 are arranged at diagonal positions in the container body 10. The forming positions of the ventilation openings are not limited to it. For example, by forming the upper ventilation openings at at least one of the upper side of the front wall and the front side of the ceiling wall and also forming the lower ventilation openings at a lower side of the rear wall, both ventilation openings can be arranged at diagonal positioned.

Further, in the present invention, the upper ventilation openings and the lower ventilation openings can be arranged at diagonal positions of the container body 10 in a front cross-sectional view. For example, by forming the upper ventilation openings at at least one of the right side of the ceiling wall 2 and the upper side of the right side wall 32 and forming the lower ventilation openings at a lower side of the left side wall 32, both ventilation openings can be arranged at diagonal positions of the container body 10 in a front cross-sectional view. Further, by forming the upper ventilation openings at at least one of the left side of the ceiling wall 2 and the upper side of the left side wall 32 and forming the lower ventilation openings at the lower side of the right side wall 32, both ventilation openings can be arranged at diagonal positions of the container body 10 in a front cross-sectional view.

As will be apparent from the above, in the present invention, by arranging the upper ventilation openings and the lower ventilation openings at diagonal positions of the container body 10 in a vertical cross-sectional view, such as a side cross-sectional view and a front cross-sectional view, an excellent aeration performance can be obtained in the same manner as mentioned above.

Further, in the aforementioned embodiment, the explanation is directed to the case in which two ventilation openings including the upper ventilation openings and the lower ventilation openings are formed. However, the present invention is not limited to it, and allows forming ventilation openings at three or more sections. In the case of forming ventilation openings at three or more sections, when two ventilation openings among three or more ventilation openings are arranged at diagonal positions, an excellent aeration performance can be obtained in the same manner as mentioned above.

Further, in the aforementioned embodiment, the explanation was made by exemplifying the animal/plant environment container in which the watertight tank section 15 was formed at the lower section of the container body 10, but the present invention is not limited to it. The present invention can be applied to an animal/plant environment container in which a watertight tank section is formed at at least the lower section of the container body 10. For example, the present invention can be applied to an animal/plant environment container in which a watertight tank section is formed up to an upper section of a container body.

The present invention can be preferably applied to a terrarium or an aqua terrarium, but not limited to it.

It should be understood that the terms and expressions used herein are used for explanation and have no intention to be used to construe in a limited manner, do not eliminate any equivalents of features shown and mentioned herein, and allow various modifications falling within the claimed scope of the present invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

1. An animal/plant environment container, comprising:
a container body including a floor, a peripheral wall, and a ceiling wall; and
a water-storable watertight tank section provided at a lower portion of the container body,
wherein a floor surface of the floor includes an inclined surface inclined downward toward a front side, and
wherein a drain hole configured to discharge water in the watertight tank section to an outside of the container body is formed at a lower end section of a front wall of the peripheral wall.

2. The animal/plant environment container as recited in claim 1, wherein an approximately entire area of the floor surface is formed into an inclined surface, and an inclination angle of the inclined surface is set to 2° to 8°.

3. The animal/plant environment container as recited in claim 1, further comprising an opening/closing member configured to open and close the drain hole.

4. The animal/plant environment container as recited in claim 1,
wherein a drain pipe is attached to a lower end section of the front wall in a manner as to penetrate the front wall, and the drain hole is formed by a pipe hole of the drain pipe.

5. The animal/plant environment container as recited in claim 4,
wherein a recessed part recessed backward and opened forward is formed in a lower end section of the front wall, and
wherein the drain pipe is arranged in the recessed part and a front end of the drain pipe is positioned rearward of a front end opening face of the recessed part.

6. The animal/plant environment container as recited in claim 1, wherein
the container body has a rectangular shape in vertical cross-sectional view,
an upper ventilation opening is provided at an upper end section of the container body,
a lower ventilation opening is provided at a lower end section of the peripheral wall, and
the upper ventilation opening and the lower ventilation opening are arranged at diagonal positions of the container body in vertical cross-section.

7. The animal/plant environment container as recited in claim 5,
wherein an upper ventilation opening is provided at at least one of a rear wall upper end section of the peripheral wall and a rear end section of the ceiling wall, and
wherein a lower ventilation opening is provided at an upper wall section among wall sections constituting the recessed part.

8. The animal/plant environment container as recited in claim 1,
wherein principal parts of the floor, the peripheral wall and the ceiling wall of the container body are constituted by transparent glass plates.
